(19) United States
(12) Patent Application Publication
(10) Pub. No.: US 2010/0107569 A1
(43) Pub. Date: May 6, 2010

(54) Plastic tube sealing and test system

(76) Inventors: Gregory L. Havemann, Palmdale, CA (US); John M. Sweeney, Palmdale, CA (US)

Correspondence Address: DENNIS W. BEECH (LAW OFFICE OF DENNIS W. BEECH), P.O. BOX 519, MURRIETA, CA, 92564-0519, US

(21) Appl. No.: 12/291,298

(22) Filed: Nov. 6, 2008

(51) Int. Cl. B65B 7/02; G01M 3/34; B65B 57/00

(52) U.S. Cl. 53/479; 53/51; 53/507; 53/75; 73/49.3

(57) ABSTRACT

The present invention may be used for plastic tube sealing and testing. A housing may have in a sealing chamber a tube sealing positioning apparatus with a tube holder slidable on a vertical guide from a lower portion to an upper portion to be positioned adjacent a heating apparatus and a clamping apparatus. The tube holder may be moved and positioned by a linear positioning device. The heating apparatus may have a nozzle to direct heated air on an open end of a plastic tube. The clamping apparatus may have two clamping devices slidably disposed to clamp the heated open end of the plastic tube to fuse the tube wall adjacent the open end. A spacing distance sensor and a tube position distance sensor may be attached to the clamping devices for sensing the position of the tube and the spacing of the clamp jaws of the clamping devise. A control processor may be connected to the linear positioning device to control movement and dwell time of the tube holder. The heating apparatus and clamp positioning device may be connected to the control processor to control heat application and clamp jaw spacing and clamp time. A sealed tube may be attached to a top cover of a test container to be positioned in the test container. A sealing disk may be positioned on the top cover to close an aperture in the cover. The sealing disk may have a port to direct a fluid pressure into a mouth of the tube and a port to apply a vacuum to the test container. The control processor may control the amount of pressure or vacuum applied on a time basis for conducting a test.

### BACKGROUND OF THE INVENTION

This invention relates to systems used to seal one end of a plastic tube that may be used to hold fluid products such as tooth paste, creams, lotions, grease and the like. The plastic tube may have a mouth end with a threaded cap or other closure element. The new system may have a tube sealing apparatus with various electronic sensing and control elements and may be combined with a tube seal and wall strength test apparatus.

Systems that may be used to fill flexible plastic tubes through an open end with a fluid product and then seal the open end may be currently known. These systems for high volume production may have a tube conveyor on which the tube open end may be oriented upwardly to receive product from a dispensing device. The tube may then be conveyed to a heating device such as a hot air blower to heat the plastic to a selected temperature approximately the melting point of the plastic and then be conveyed to a jaw clamping device to press or crimp the open end plastic wall together to heat seal the open end.

While this may be considered a relatively simple process, various parameters associated with plastic tubes, for example, thickness of walls or other dimensions, and plastic composition that may affect the melt flow index, may affect the quality of the tube heat seal. Currently known methods for producing product filled plastic tubes may not incorporate testing methods and apparatus to test plastic tubes to ensure the tubes will be properly sealed in production to avoid failure of the seal or the wall of a tube when delivered to the consumer.

### SUMMARY OF THE INVENTION

The present invention is directed to apparatus for plastic tube sealing and testing. A housing may have in a sealing chamber a tube sealing positioning apparatus with a tube holder slidable on a vertical guide from a lower portion to an upper portion to be positioned adjacent a heating apparatus and a clamping apparatus. The tube holder may be moved and positioned by a linear positioning device. The heating apparatus may have a nozzle to direct heated air on an open end of a plastic tube. The clamping apparatus may have two clamping devices slidably disposed to clamp the heated open end of the plastic tube to fuse the tube wall adjacent the open end. A spacing distance sensor and a tube position distance sensor may be attached to the clamping devices for sensing the position of the tube and the spacing of the clamp jaws of the clamping devise. A control processor may be connected to the linear positioning device to control movement and dwell time of the tube holder. The heating apparatus and clamp positioning device may be connected to the control processor to control heat application and clamp jaw spacing and clamp time. A sealed tube may be attached to a top cover of a test container to be positioned in the test container. A sealing disk may be positioned on the top cover to close an aperture in the cover. The sealing disk may have a port to direct a fluid pressure into a mouth of the tube and a port to apply a vacuum to the test container. The control processor may control the amount of pressure or vacuum applied on a time basis for conducting a test.

These and other features, aspects and advantages of the present invention will become better understood with reference to the following drawings, description and claims.

### BRIEF DESCRIPTION OF THE DRAWINGS

FIG. 1 illustrates a front elevation view with the front panel cut away showing the major electro-mechanical elements of a plastic tube sealing and test system according to an embodiment of the invention;

FIG. 2 illustrates a side elevation view with side panel removed of the system according to an embodiment of the invention;

FIG. 3 illustrates a top view with the top panel removed of a portion of the electro-mechanical elements of the system according to an embodiment of the invention;

FIG. 4 illustrates a schematic of the electrical and fluid elements of the system according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

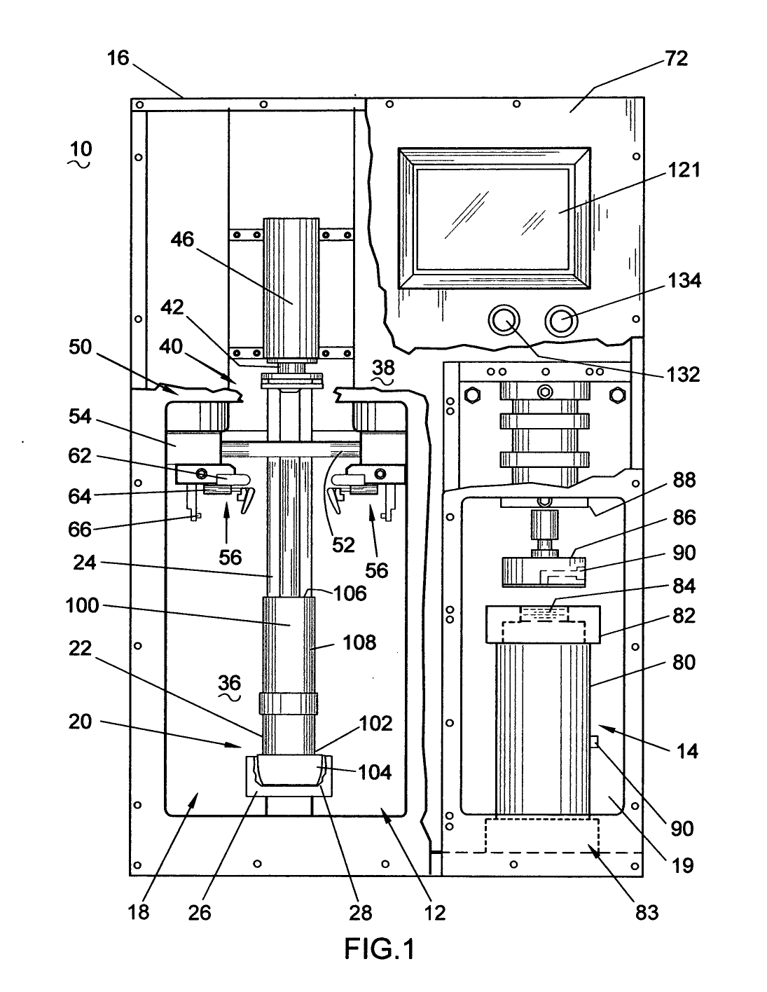

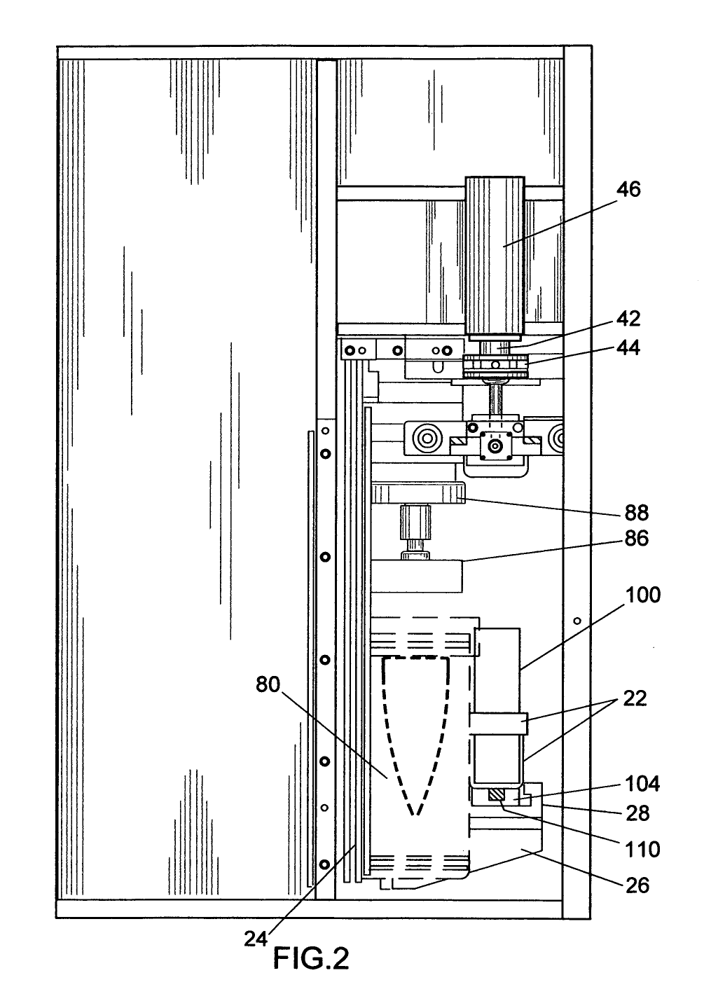

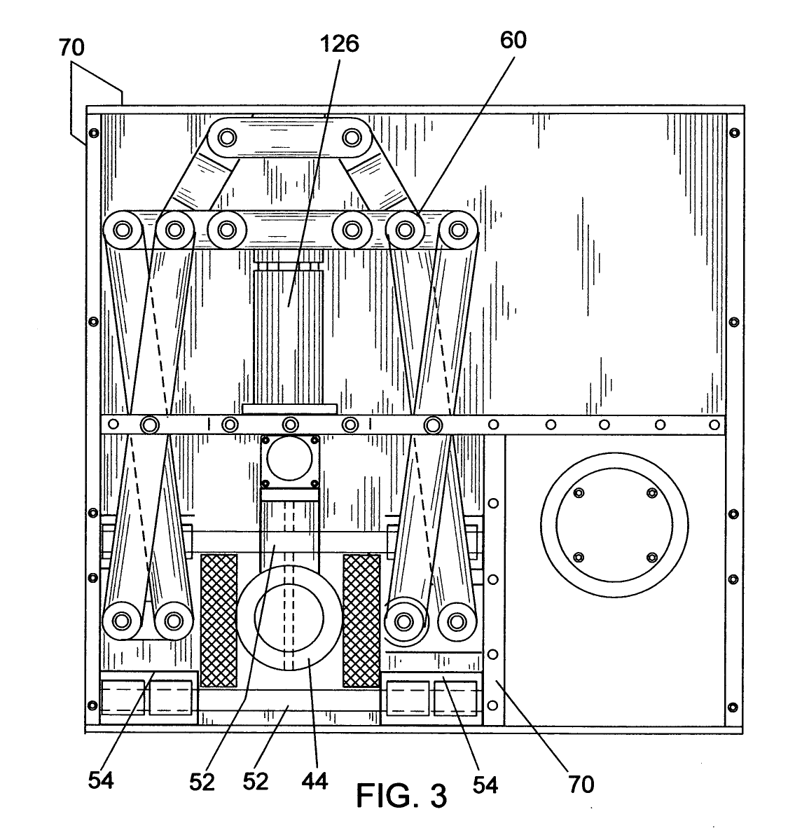

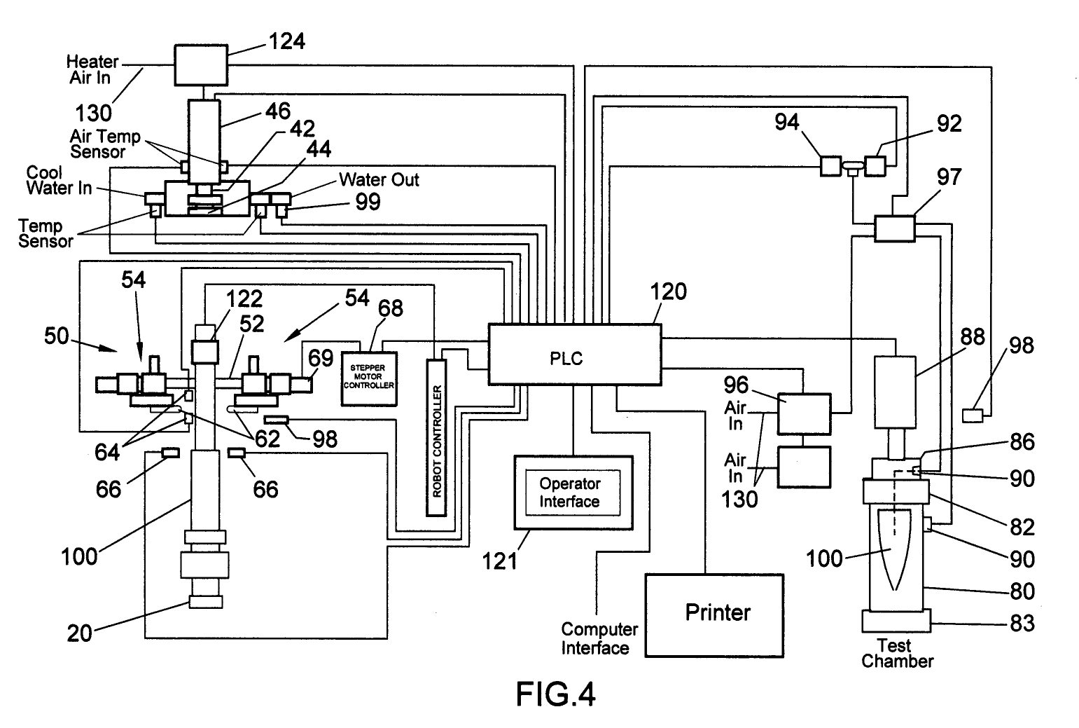

Referring to FIGS. 1 through 4, a tube sealing apparatus 12 is illustrated as positioned in the left portion of a combined tube sealing and test system 10 enclosure and a tube seal and wall strength test apparatus 14 is illustrated as positioned in the right portion. While for purposes of this description the two apparatus 12, 14 are illustrated in a combined housing 16, it may be understood that each may also be used separately for purposes such as sealing tubes in an assembly operation if modified or testing tubes sealed for example on an assembly line.

The tube sealing apparatus 12 may have a tube sealing positioning apparatus 20 with a tube holder 22 slideably attached to a vertical guide 24 that extends from a generally lower portion 36 of the sealing chamber 18 to an upper portion 38 adjacent a tube heating apparatus 40. The tube holder 22 may be raised and lowered in the sealing chamber 18 using a hydraulic or pneumatic device, an electric motor device or other suitable linear positioning device 122. The tube holder 22 may have a generally horizontal holder 26 for receipt of a tube mouth end fixture 28 into which the mouth end 102 of a plastic tube 100 may be inserted. Multiple fixtures 28 may be used that may be sized to receive various shapes and sizes of tube mouth ends 102 including the cap 104 of a tube 100 if attached to the mouth end 102.

The tube heating apparatus 40 may be positioned in the upper portion 38 of the sealing chamber 18 positioned for a plastic tube 100 raised by the tube holder 22 to have the open end 106 positioned adjacent a heater nozzle 42 of an air heater element 46. The heater nozzle 42 may be a replaceable or interchangeable attached nozzle to allow attachment of nozzle sizes and shapes to mate with different configuration plastic tubes 100. The heating device 46 may be an electric heating element to receive air from an air blower or receive compressed air from an air flow controlled source 124 as may understood in the art that may be controlled by a processor 120 that may be a digital processor, microprocessor, computer or the like that may be connected to a display device 121. A cooling ring 44 may be positioned around the heating nozzle 42 as an element to further control the temperature of air directed on the tube 100.

Intermediate the tube positioning apparatus 20 and the heating apparatus 40, a clamping apparatus 50 or crimping apparatus may be positioned to press or crimp the open end 106 plastic wall 108 to fuse the open end in a heat seal manner. The clamping apparatus 50 may have one or more generally horizontal bars 52 attached to opposed frames 70 of the housing 16. Two opposed clamping devices 54 may be slidably mounted on the bars 52 and may be moved from an open position 56 to an approximately closed position 58 by a lever arm device 60 or toggle clamp powered by a clamp positioning device 126, for example, a hydraulic or pneumatic actuator.

The opposed clamping devices 54 may each have a clamping jaw 62 located to be positioned adjacent to each other at a distance commanded by the processor 120. The spacing distance of the two jaws 62 when moved to a position adjacent may be calculated based on the parameters of each type of plastic tube 100. For purposes of positioning and control the clamping devices 54 may have a spacing distance sensor 64 such as a laser gap sensor and may have a tube position sensor 66 such as an optical sensor to detect the top of the open end 106 of a tube 100.

The tube sealing apparatus 12 may have a plastic tube 100 positioned on the tube holder 22; the tube holder 22 may be raised until the open end 106 of the tube 100 is sensed by the tube position sensor 66 to determine the distance to the heater nozzle 42 or the distance from the tube holder 22 to the open end 106; the tube holder 22 may then be moved to place the open end 106 adjacent the heater nozzle 42 to heat the tube 100 for a defined time; when the defined time has elapsed, the tube 100 may be lowered to position the tube wall 108 area adjacent the open end 106 between the jaws 62; and the jaws 62 may be closed to a predetermined distance and maintained in a clamped position for a predetermined time to seal the tube 100. A tube 100 sealed in this process may then be tested in a vacuum or pressure chamber apparatus to determine the strength of the sealed tube 100.

The processor 120 may have software or firmware modules for controlling the tube holder 22 movement and positioning, for example, a loop crimping gap setting module, that receives signals from the spacing distance sensor 64 and a stepper motor control device 68 that may control an electric motor 69 to move the clamping apparatus 50. There may also be parts per minute based timing for sealing process module 74 to control the time for tube 100 heating and for jaw 62 clamp time to simulate production cycling for tube sealing as well as to vary timing to test improved sealing parameters or marginal production process times. There may be temperature control program modules to sense and allow control of hot air or fluid control for heating the tube 100. A data processing software module may control and collect data, such as crimp gap during crimping, temperature during tube heating and heating change during crimping time.

A tube seal and wall strength test apparatus 14 may be used in a stand alone test station to test tubes 100 or may be integrated with a tube sealing apparatus 14 as illustrated in the Drawings. The tube test apparatus 14 may have a test container 80 that may be generally cylindrical in shape with a top cover 82 removable and having an attachment aperture 84 therein for threadable attachment of a threaded mouth 110 of a plastic tube 100.

The top cover 82 and attachment aperture 84 may have other attachment mechanisms for attachment of non-threaded tubes 100. A tube 100 may be attached at a mouth end 102 in the attachment aperture 84 and the top cover 82 may be placed on the test container 80 with the tube 100 in the test container 80. The test container 80 may then be positioned in the tube test apparatus 14. A sealing disk 86 controlled by a position activator 88, such as a hydraulic or pneumatic piston, may be positioned on the top cover 82 to close the aperture 84. The sealing disk 86 may have one or more ports 90 in communication with the tube mouth 100 to allow fluid pressure to be applied to the interior of the tube 100 and with the interior of the test container 80 to allow a vacuum to be applied in the test container 80. The ports 90 may be connected to a vacuum pump or venturi 128 and a fluid, for example, compressed air, source 130.

The processor 120 may have software or firmware modules for controlling the test apparatus 14 pressure and vacuum testing, for example, a module to allow entering: pressure and vacuum set points, speed of ramp up to pressure or vacuum, and dwell time at set points. There may be a data output of the vacuum transmitter 92 and pressure transmitter 94 to the processor 120 for use in control of vacuum and pressure and to detect a sudden change when a tube 100 fails or there may be a leak of pressure or vacuum. A data processing software module may control and collect data, such as failure pressure or vacuum, test time and time of failure, and failure type that may be entered by a user to indicate tube wall or tube seal failure.

The tube test system 10 may have a display 121 on the front panel 70 for use in display of apparatus settings, test results, switch images for touch panel control, as well as display of other elements, for example, an internal processor 120 program functions and status. An emergency stop switch 132 and an on/off switch 134 may also be located on the front panel. The sealing chamber 18 and test chamber 19 may have movable doors for closing to protect a user from any unexpected circumstances. The doors may have sensors 98 that signal the processor 120 to inhibit operation of the tube sealing apparatus 12 and test apparatus 14 if the door is not closed. Also, a water pressure sensor 99 may signal the processor 120 to turn off the heating apparatus 40. The processor may be programmed to return the horizontal holder 26 to the lower portion 36 of the sealing chamber 18 at the end of the sealing process or if the sealing process is interrupted. These processes may be considered to be safety features.

The positioning of the tube sealing apparatus 12 elements may be useful for production of sealed product tubes 100. Current practice appears to move tubes from a heating station to a sealing station. This two step process may not be as repetitively reliable as the combination heating and sealing in one apparatus as described.

While the invention has been particularly shown and described with respect to the illustrated embodiments thereof, it will be understood by those skilled in the art that the foregoing and other changes in form and details may be made therein without departing from the spirit and scope of the invention.

I claim:

1. An apparatus for sealing tubes comprising:
a housing having a sealing chamber;
a tube sealing positioning apparatus has a tube holder slidably attached to a vertical guide that extends from a generally lower portion of said sealing chamber to an upper portion of said sealing chamber and said tube holder is movable by a linear positioning device;
a tube mouth end fixture sized for receipt of a mouth end of a tube is insertable in said tube holder;
a heating apparatus is attached in said upper portion of said sealing chamber disposed for a heater nozzle that is interchangeable to be positioned adjacent an open end of said tube when said tube is raised in said sealing chamber;
a clamping apparatus with two clamping devices slidably disposed on a bar attached to said housing in said sealing chamber intermediate said tube sealing positioning apparatus and said heating apparatus wherein each of said clamping devices has attached a sealing jaw, a spacing distance sensor and a tube position sensor, and said two clamping devices are positionable between a first spaced apart position and a second adjacent position by a clamp positioning device; and
a control processor is connected to said linear positioning device, said heating apparatus and said clamp positioning device.

2. The apparatus as in claim 1 wherein said tube holder has a horizontal holder attached for receipt of said tube mouth end fixture.

3. The apparatus as in claim 1 wherein said control processor is programmed to process said tube position sensor detection of said open end of said plastic tube to determine the positioning adjacent said heating apparatus and to determine the heating dwell time and the clamping dwell time.

4. The apparatus as in claim 1 wherein said heating apparatus has a forced air blower and heating element controllable by said control processor.

5. The apparatus as in claim 1 wherein said heating apparatus has a compressed air source and heating element controllable by said control processor.

6. The apparatus as in claim 1 wherein said clamp positioning device has a lever arm device attached to each of said clamping devices.

7. The apparatus as in claim 1 wherein said control processor is programmed to receive the material parameters of said plastic tube and to convert said material parameters to a heating time and temperature and to a clamping time and a clamp jaw spacing distance.

8. The apparatus as in claim 1 wherein an electronic display is connected to said control processor and said electronic display is a touch panel display.

9. The apparatus as in claim 1 wherein a printer is connected to said control processor.

10. The apparatus as in claim 1 wherein said control processor is a computer.

11. The apparatus as in claim 1 wherein said housing has a tube test apparatus disposed in a test chamber further comprising:
a test container with a top cover removably disposed in said test chamber;
said top cover having an aperture therein for attachment of a mouth end of said tube oriented to position said tube in said test container when said top cover is on said test container;
a sealing disk controlled by a position actuator disposed in said test chamber above said test container and said sealing disk having a pressure port formed to engage said top cover aperture and a vacuum port formed to engage the interior of said test container; and
a fluid pressure device connected to said pressure port and a vacuum device connected to said vacuum port.

12. The apparatus as in claim 11 wherein said position actuator is a pneumatic position activator controlled by said control processor.

13. The apparatus as in claim 11 wherein said fluid pressure device pressure level and time are controlled by said control processor.

14. The apparatus as in claim 11 wherein said vacuum device vacuum level and time are controlled by said control processor.

15. The apparatus as in claim 1 wherein said tube is a plastic material tube.

16. A method for sealing tubes comprising:
placing a tube in an apparatus as claimed in claim 1;
raising a tube holder until an open end of said tube is sensed by the tube position sensor;
determining the distance between the heater nozzle and said open end;
moving said tube holder to position said open end adjacent the heater nozzle and activating the heating apparatus to cause a heated fluid to impinge on said open end for a defined time period controlled by the control processor; and
moving said tube holder to position a tube wall area adjacent said open end between the sealing jaws and moving the sealing jaws to a closed position for a defined time period controlled by the control processor.

17. The method as in claim 16 further comprising:
recording data for display and action by a user that is the crimp gap during crimping, the temperature during tube the heating and heating changes during tube heating.

18. A method for testing tubes comprising:
positioning a tube in an apparatus as claimed in claim 10;
entering test parameters in the control processor of a set point, a speed of ramp up to said set point and a dwell time at said set point selected for one of the testing of pressure and vacuum strength of said tube; and
activating the processor to detect and control said test parameters and to detect said tube failure.

19. The method as in claim 18 further comprising:
recording data for display and action by a user that is pressure and vacuum values correlated to test time, failure of pressure and vacuum, test time at failure, and failure type.

20. An apparatus for testing sealed tubes comprising:
a housing having a test chamber;
a test container with a top cover removably disposed in said test chamber;
said top cover having an aperture therein for attachment of a mouth end of said tube oriented to position said tube in said test container when said top cover is on said test container;
a sealing disk controlled by a position actuator disposed in said test chamber above said test container and said sealing disk having a pressure port formed to engage said top cover aperture and a vacuum port formed to engage the interior of said test container; and
a fluid pressure device connected to said pressure port and a vacuum device connected to said vacuum port.
